(19) United States
(12) Patent Application Publication
(10) Pub. No.: US 2005/0025130 A1
(43) Pub. Date: Feb. 3, 2005

(54) Method for signaling of call diversion parameters in a SIP network

(76) Inventor: Klaus Hoffmann, Munchen (DE)

Correspondence Address: SIEMENS CORPORATION, INTELLECTUAL PROPERTY DEPARTMENT, 170 WOOD AVENUE SOUTH, ISELIN, NJ, 08830, US

(21) Appl. No.: 10/849,592

(22) Filed: May 20, 2004

(30) Foreign Application Priority Data
May 23, 2003 (DE) 10323403.9

(51) Int. Cl. H04L 12/66

(52) U.S. Cl. 370/352

(57) ABSTRACT

The invention relates to a method for signaling call diversion parameters in a SIP network (12), according to which to signal the call diversion a Provisional Response 18× or a Response 3×× according to IETF RFC 3261 is used, which comprises diversion codes. For connections between the SIP network (12) and a further network (3) the invention also provides a [lacuna] for the bi-directional conversion of SIP messages or SIP-T messages to a protocol of the further network (3).

### CROSS REFERENCE TO RELATED APPLICATIONS

This application claims priority to the German application No. 10323403.9, filed May 23, 2003 and which is incorporated by reference herein in its entirety.

### FIELD OF INVENTION

The invention relates to a method for signaling of call diversion parameters in a SIP network.

### BACKGROUND OF INVENTION

Packet-oriented voice networks, also known as Voice over Packet VoP networks, are increasingly replacing or supplementing conventional public switched telephone networks PSTN. At the same time hitherto separate, dedicated networks for data transmission and voice transmission are merging in a single network, frequently referred to as a convergent or next generation network NGN.

The network access units for users of packet-oriented networks are what are known as Media Gateways, which are connected on the one hand to the user terminals and on the other hand to the remainder of the network. Media Gateways also serve to connect PSTN sections to the packet-oriented networks.

In communication networks of the type under consideration a distinction is frequently made between signaling information and useful information (e.g. payload). Signaling information relates for example to the setting up, canceling and further control processes of a connection, whereby the useful information is transmitted for example between two users via the connection.

There are therefore two at least logically different subnetworks in the communication network: the subnetwork for signaling and the subnetwork for useful information. If there is a connection in the subnetwork for useful information, it is frequently referred to as the traffic or bearer channel.

In the packet-oriented network useful information is forwarded via the said Media Gateways, while signaling information is analyzed and transported by Media Gateway Controllers. The Media Gateway Controllers (MGC) control the Media Gateways (MG) in response to the signaling information and said Media Gateways in turn convert the control received to an influence on the traffic channels.

Different signaling protocols are provided for communication between MGCs. These include for example BICC CS2 (Bearer Independent Call Control-Capability Set 2) according to ITU-T Q.1902. X, in conjunction with a specific Service Indicator (SI) for the Message Transfer Part (MTP) and Q.765.5 Bearer Application Transport (BAT). In the event that the Real-Time Protocol (RTP) is provided in the packet-oriented network, this standard describes options for provided known PSTN services in a network arrangement, with which two PSTN sections are connected by means of the packet-oriented network. Such a network arrangement is shown as an example in FIG. 1.

FIG. 1 shows schematically how the information required to set up a communication connection between two telecommunication terminals 1, 2 is exchanged between the individual network components, when the signaling and traffic channel are separate. An A user thereby asks an associated local exchange (LE) 5 for a call to be set up to a telecommunication terminal 2 of a B user via a telecommunication terminal 1, which is linked to a first PSTN 3.

This call request causes a connection to be set up via two MGCs 6, 7. Information is thereby transmitted by means of a corresponding signaling protocol to a first Media Gateway Controller 6. In practice signaling system no. 7, also known as the Common Channel Signaling System 7 (CCS7 or SS7) is used as the signaling protocol, whereby ISDN User Part (ISUP) messages are used specifically to set up the connection.

The MGC 6 for its part communicates with a second Media Gateway Controller 7 by means of a further signaling protocol, e.g. BICC CS2. The second MGC 7 thereby receives all the signaling information relating to service or performance features and transmits this information to a PSTN 4, in which the terminal 2 of the B user is arranged. Transmission takes place in turn via a corresponding signaling protocol, in a PSTN generally CCS7 again.

As well as the above-mentioned further signaling protocol BICC CS2 for MGC-to-MGC communication, the IETF has produced the standards RFC 3261 (SIP=Session Initiation Protocol) and RFC 3204 (ISUP MIME Type), which allow the tunnel transport of ISUP messages in SIP messages. Such SIP messages for MGC-to-MGC communication are also referred to as SIP-T messages.

FIG. 1 also shows a network element 15, which is frequently referred to as Call Mediation Node CMN. This network element 15 is used for the transfer of signaling messages, whereby the CNN can also effect a conversion between different signaling protocols.

In the example in FIG. 1 a SIP network 12 is connected to the remainder of the signaling elements via the network element 15. The SIP network useful channel connection has not been shown. The SIP network 12 for example comprises a SIP proxy 13 and a SIP user 14.

It has proven disadvantageous that with current implementations the signaling of call diversions, in particular the signaling of the reason for the call diversion, cannot be effected in the manner expected by users of modern communication networks and as known from conventional telephone networks. Nor is it possible to transmit the new destination call number in the case of a call diversion (ISUP redirection number) in current SIP implementations.

An IETF internet draft entitled “draft-levy-sip-diversion-05.txt” deals with “call diversion” topics for a purely SIP environment.

IETF RFC 3398 “ISUP to SIP Mapping” covers the case of a combined ISUP-SIP environment. The mechanisms contained in this RFC do not however provide signaling for the reason for the call diversion or for the new destination call number, if the transition exchange remains in the connection, perhaps to provide and/or control further services. In known documents clearance of the connection is assumed in a backward direction within the PSTN to a switching center in front, in which call diversion then takes place.

### SUMMARY OF INVENTION

The object of the invention is therefore to specify a method, with which it is possible to signal the reason for the call diversion and the new destination call number in a SIP network, if a SIP network unit remains in the connection. A further object of the invention is to specify a method, with which it is possible to signal the reason for the call diversion and the new destination call number between an ISUP/BICC network and a SIP network.

This object is achieved by an inventive method for signaling call diversion parameters in a SIP network, according to which a Provisional Response or a Response according to IETF RFC 3261 is used to signal the call diversion, said response comprising diversion codes, which preferably contain at least information relating to the reason for the diversion and the diversion destination.

These diversion codes can be configured as diversion headers, which are advantageously defined as follows based on “draft-levy-sip-diversion-05.txt”:

| | where | enc. | e-e | ACK | BYE | CAN | INV | OPT | REG |
|---|---|---|---|---|---|---|---|---|---|
| Diver- | 181 | | h | — | — | — | o | — | — |
| sion | | | | | | | | | |

For connections between the SIP network and a further network, SIP messages or SIP-T messages are advantageously bidirectionally converted to a protocol of the further network. The invention thereby allows SIP users to use all known performance features in the event of call redirection, in particular the reason for the call diversion and the new destination call number.

The present invention also has the following advantages:
1. During the transfer of a connection from a SIP network to a PSTN/BICC network, a calling SIP user (Calling Party, A user) can make full use of the call diversion service, if a called PSTN user (Called Party, B user) implements the call diversion. During the call diversion the switching center in the PSTN, at which the diversion is implemented, generally remains in the connection. Similarly the signaling messages can be converted, if the B user is a Voice over DSL user or an H.323 user.

2. During the transfer of a connection from the PSTN/BICC network to a SIP network, a calling PSTN user can make full use of the call diversion service, if a called SIP user implements the call diversion.

3. If the connection and diversion take place completely within the SIP network, i.e. the source, the original destination and also the call diversion destination are within the SIP network, the invention can be deployed, if the service provider:
a) is interested in business models perhaps for the provision of their own IN services, from a service point of view, or
b) is interested from a commercial point of view in only allowing specific services with their service computers, for example to ensure that the infrastructure is not abused, by perhaps preventing a higher bandwidth being used than is permitted and billed for or a codec being used that has not been registered, or
c) has an interest on account of a request to monitor (lawful interception) the originally dialed B user in leaving or is forced to leave an IP/IP Gateway in the connection, for example because the RTP data stream has to be doubled for the monitoring tap.

In the case of interworking of a SIP network and an ISUP/BICC network, the messages can be converted from BICC/ISUP to SIP/SIP-T and vice-versa preferably according to Table 1:

TABLE 1

| ISUP/BICC | SIP |
|---|---|
| IAM | INVITE |
| Original Called Number | (Diversion Header, |
| Redirecting Number | (name-addr, |
| Redirection Information (reason, | reason, counter, limit)) |
| counter) | |
| ACM, CPG | Provisional Response 18x (in response |
| Call Diversion Parameter | to INVITE) |
| Redirection Number | (Diversion Header, (reason)) |
| | Diversion Header (name-addr) |
| ACM, CPG | 3xx response (to INVITE) |
| Call Diversion Parameter | (Diversion Header, (reason)) |
| Redirection Number | Diversion Header (name-addr) |
| | Contact |

Unlike the responses 3×× used by SIP nodes no longer in the connection, in the Provisional Responses 18×, which are sent in the direction of the calling user by the SIP nodes remaining in the connection in the event of the diversion, the diversion header is provided with a communication address for the diversion destination.

With the Responses 3××, defined in RFC 3261, the previous SIP element is informed in a backward direction in relation to the connection set-up by a SIP element closer to the destination in response to an INVITE message received by the previous SIP element, that at least one alternative destination, e.g. a diversion destination, exists, to which the INVITE message is to be sent to continue connection set-up.

A CONTACT header is deployed for this purpose. Sending the Response 3×× also indicates that the SIP element closer to the destination, which sends the Response 3××, should not be included in the further connection set-up and the ultimately established connection.

In contrast a Provisional Response 18×sent by the SIP element closer to the destination indicates that the connection has not yet been established, for example the user is being called or a diversion is being diverted in this SIP element closer to the destination or in a SIP element even closer to the destination. The SIP element closer to the destination thereby also indicates implicitly that it will remain in the further connection set-up.

In one aspect of the invention an option is provided for what are known as recursing SIP proxy elements for redirecting the information about the network element through which the diversion has been effected and what the reasons were for the diversion in a backward direction, i.e. in the direction of the calling user.

In RFC3261, chapter 16.7 “Response processing” it is specified that a SIP element, which receives a Response 3××, can itself remain in the connection. A SIP element or SIP proxy, is referred to as recursing, if the SIP element or SIP proxy remains in the connection on receipt of a Response 3×× and sends the INVITE to the new destination.

Exemplary reasons for the recursing response of a SIP element are, as set out above, charging, the provision of further service features during the course of connection set-up or the connection, lawful interception.

A non-recursing SIP element or SIP proxy is however defined as an element which redirects the Response 3×× and thereby indicates in a backward direction that said SIP element or SIP proxy is not to be included in the further connection set-up and the ultimately established connection.

According to the aspect of the present invention, for a recursing SIP element or a recursing SIP proxy, or more generally for the first SIP node or SIP proxy, which remains in the connection, the Responses 3×× received by said nodes are converted to Provisional Responses 18×redirected by said nodes, preferably according to Table 2 below:

TABLE 2

| SIP Response 3xx | SIP Provisional Response 18x |
|---|---|
| (Diversion Header, (reason)) | (Diversion Header, (reason)) |
| Diversion Header (name-addr) | Diversion Header (name-addr) |
| Map CONTACT on Diversion Header | |

The invention is described in more detail below with reference to an exemplary embodiment in conjunction with drawings, in which:

### BRIEF DESCRIPTION OF THE DRAWINGS

FIG. 1 shows a network arrangement, with which two PSTN sections are connected by means of a packet-oriented network and

FIGS. 2A-C show different stages of integration of a section of a signaling network, which comprises both PSTN signaling and SIP signaling.

### DETAILED DESCRIPTION OF INVENTION

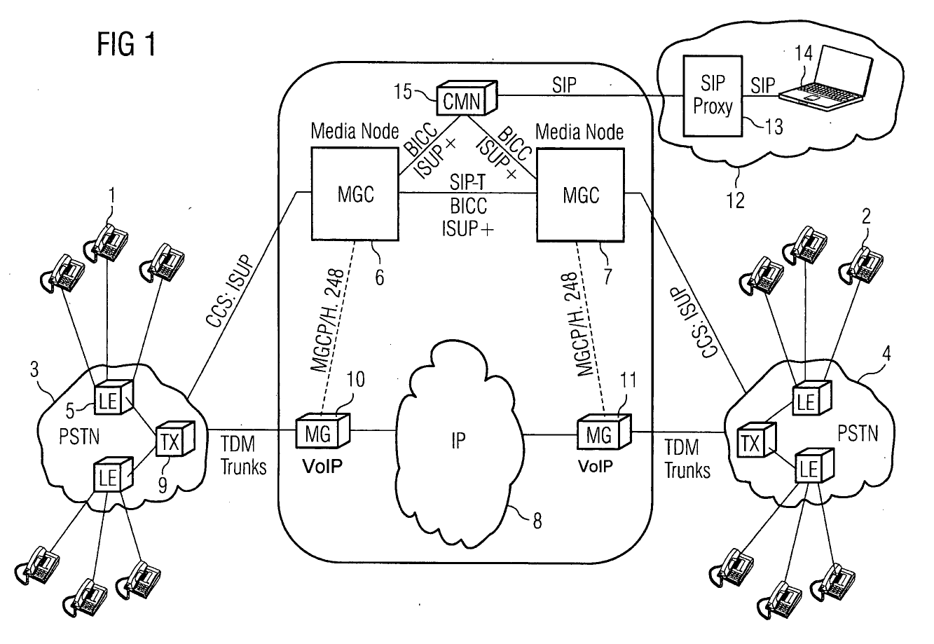

FIG. 1, as already described, shows a network arrangement, which illustrates the case where two PSTN sections 3, 4 are connected by means of a packet-oriented network 8. The connection control information is thereby directed via Media Gateway Controllers 6, 7, while the useful information is directed via Media Gateways 10, 11. In conjunction with the present invention the SIP or SIP-T protocol is deployed between the MGCs 6, 7, whereby conversion between the PSTN signalings and SIP can for example be effected according to Table 1 above.

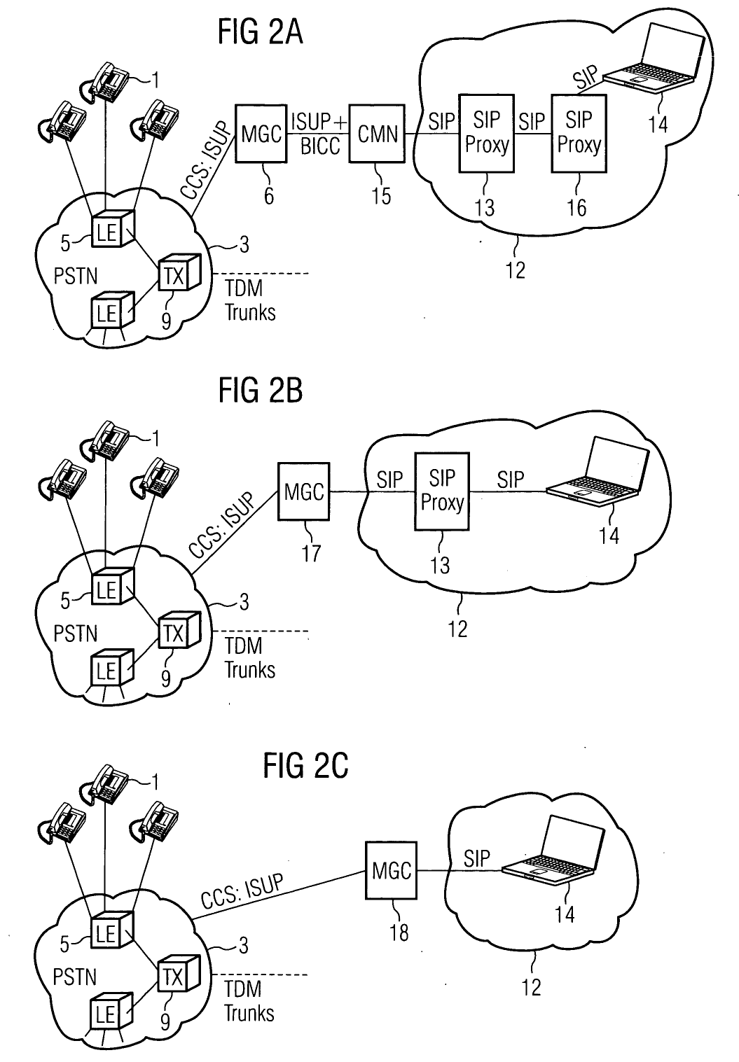

FIG. 1 also shows a SIP network 12, which comprises for example a SIP proxy 13 and a SIP terminal 14 and is connected by means of SIP to the Call Mediation Node 15, whereby only the signaling connections are shown schematically. This section of the signaling network is shown in more detail in FIGS. 2A-C.

FIG. 2A shows a section of the network arrangement from FIG. 1, in which the PSTN 3 is connected to the SIP network 12. Only the signaling connections and signaling network elements are shown here in FIG. 2A.

In the example in FIG. 2A, the PSTN 3 is connected by means of the ISDN User Part ISUP to the MGC 6. The MGC is connected by means of BICC or ISUP+ to the CMN 15. The CMN 15 is connected by means of SIP to the first SIP proxy 13, which in turn is connected by means of SIP to a second SIP proxy 16. The SIP terminal 14 is finally connected to the second SIP proxy 16. The two SIP proxies 13, 16 and the SIP terminal 14 thereby form the SIP network 12.

The signaling of a connection request from a user terminal of the PSTN, for example terminal 1, to the SIP terminal 14 is effected in the example in FIG. 2A as follows: the connection request is generated in the PSTN and directed by means of ISUP to the MGC 6, converted there to ISUP+ or BICC and redirected to the CMN 15. In the CMN 15 conversion takes place to SIP and the connection request is redirected to the SIP network 12, here the first SIP proxy 13 and on to the second SIP proxy 16. The connection request is finally directed from the second SIP proxy 16 to the SIP terminal 14.

Let us now look at the case where the SIP terminal 14 signals a call diversion using a Response 3×× in response to the connection request, which is transmitted in the form of an INVITE message to the terminal, to a diversion destination (not shown).

Alternatively another SIP element, for example the second SIP proxy 16, can send the Response 3×× in response to the connection request on behalf of the SIP terminal 14, without the connection request being redirected at all to the SIP terminal 14, perhaps in the event of a permanent call diversion stored in the SIP network in relation to the SIP terminal 14.

In principle all four of the signaling elements 6, 15, 13, 16 shown are actually able to execute the diversion.

More specifically the diversion can be executed by the second SIP proxy 16, whereby in this case (case 1) all elements 6, 15, 13, 16 remain in the connection.

On the other hand the diversion can also be executed by the first SIP proxy 13, whereby the second SIP Proxy 16 then does not remain in the connection (case 2).

The diversion can also be executed by the CMN 15, whereby in this case (case 3) none of the SIP proxies 13, 16 remains in the connection.

Finally provision can also be made (case 4) for none of the signaling elements apart from the MGC 6 to remain in the connection, whereby the diversion is then implemented by the MGC 6. There is also the case where the connection in the PSTN is diverted and this is considered in conjunction with case 4.

Table 3 below shows the messages sent in each instance between the network elements MGC 6, CMN 15, first SIP proxy 13 and second SIP proxy 16 in a backward direction in relation to connection set-up for the cases 1-4 as set out above:

TABLE 3

| | Terminal 14 -> Proxy | Proxy 16 -> | Proxy 13 -> | CMN 15 -> | MGC 6 -> |
|---|---|---|---|---|---|
| | 16 | Proxy 13 | CMN 15 | MGC 6 | PSTN 3 |
| Case 1 | Response 3xx | Prov. Response | Prov. Response | CPG | CPG |
| | | 18x | 18x | | |
| Case 2 | Response 3xx | Response | Prov. Response | CPG | CPG |
| | | 3xx | 18x | | |
| Case 3 | Response 3xx | Response | Response | CPG | CPG |
| | | 3xx | 3xx | | |
| Case 4 | Response 3xx | Response | Response | REL | CPG |
| | | 3xx | 3xx | | |

CPG here stands for the ISUP message Call Progress, which is used during connection set-up, particularly in relation to the signaling of call diversions. REL is the ISUP message Release, which is used to clear a connection section (here between CMN 15 and MGC 6).

It should be noted that Table 3 only shows examples of the messages to be sent. Between CMN 15 and MGC 6 the messages are shown as ISUP or ISUP+messages. If another protocol is used for communication between these two network elements, the messages received by the CMN 15 will be mapped accordingly onto equivalent messages of the other protocol.

Case 4 also comprises a particularity in that for case 4, in which even the CMN 15 does not remain in the connection, the branch of the connection between MGC 6 and CMN 15 is cleared by means of a REL message. To ensure the signaling of the diversion codes, particularly the diversion destination, reason for diversion and initiating network element, the information in the SIP Response 3×× is mapped according to the invention, as disclosed in Table 4 below, onto said REL message:

TABLE 4

| SIP | ISUP/BICC |
|---|---|
| Response 3xx | REL with Cause 31 (optional) |
| (Diversion Header, (reason)) | Parameter “Redirection Information” |
| Diversion Header (name-addr) | contains reason |
| Contact | Redirection number |

The BICC/ISUP switching element, which receives the REL message thus parameterized and executes the diversion, by for example sending an IAM to the new destination, generates a CPG from the received REL, whereby the information elements contained can be converted as specified in Table 5 below:

TABLE 5

| ISUP/BICC | ISUP/BICC |
|---|---|
| REL with Cause 31 (optional) | ACM, CPG |
| Parameter “Redirection Information” | Call Diversion Parameter |
| (contains reason) | Redirection Number |
| Redirection number | |

In the example in FIG. 2A the BICC/ISUP switching element, which converts the REL to the CPG, is the CMN 15. This conversion can also be effected, if the connection in the PSTN is diverted.

The protocol conversions taking place in the cases 1-4 disclosed above are listed in Table 6 below:

TABLE 6

| | Conversion | Conversion | Conversion |
|---|---|---|---|
| | location | from-to | shown in |
| Case 1 | Second Proxy 16 | Response 3xx to | Table 2 |
| | | Prov. Response 18x | |
| Case 2 | First Proxy 13 | Response 3xx to | Table 2 |
| | | Prov. Response 18x | |
| Case 3 | CMN 15 | Response 3xx to CPG | Table 1 |
| Case 4 | MGC 6 | Response 3xx to REL | Table 4 |

FIGS. 2B and 2C also show a schematic illustration of the section of the network arrangement from FIG. 1 already considered in conjunction with FIG. 2A. FIGS. 2B and 2C thereby show different stages during the integration of the functions of the network elements 6, 15, 13, 16 from FIG. 2A.

In FIG. 2B an extended MGC 17 includes the functionality of the MGC 6 and the CMN 15. This means that conversion from ISUP/BICC to SIP and vice versa is effected by the extended MGC 17. Also only one SIP proxy 13 is shown in the illustration in FIG. 2B.

FIG. 2C shows a further extended MGC 18, which comprises the functionality of a SIP proxy in addition to the functionality of the MGC 17 from FIG. 2B. This means that the SIP user 14 can be connected directly to the MGC 18.

Other, alternative configurations of the signaling for call diversions by means of the Session Initiation Protocol SIP include the insertion of the diversion header for other appropriate response messages.

The invention can therefore also be used, where a conversion from ISUP messages and parameters to SIP messages and parameters is not effected directly but other protocols first record the information content of the ISUP messages and parameters, before effecting conversion to SIP (not shown). Such an intermediate protocol, for example on the path between the PSTN and the SIP network, can for example be BICC.

Conversion from SIP/SIP-T to other protocols can also be effected in a similar manner, for example to analog user connection protocols, digital user connection protocols (e.g. DSS1), protocols for mobile radio applications, Voice over DSL VoDSL or ITU-T H.323.

The invention can also advantageously be used, if sips are deployed between media gateway controllers, to connect two PSTN sections together.

1.-11. (cancelled)

12. a method for signaling call diversion parameters in a sip network, comprising:
signaling the call diversion by using a Provisional Response or a Response according to IETF RFC 3261, which comprises diversion codes.

13. The method according to claim 12, wherein the diversion codes comprise information relating to the reason for the diversion and the destination of the diversion.

14. The method according to claim 12, wherein the diversion codes are formed by a diversion header, which is defined as follows:

| | where | enc. | e-e | ACK | BYE | CAN | INV | OPT | REG |
|---|---|---|---|---|---|---|---|---|---|
| Diver- | 18x | | h | — | — | — | o | — | — |
| sion | | | | | | | | | |

15. The method according to claim 13, wherein the diversion codes are formed by a diversion header, which is defined as follows:

| | where | enc. | e-e | ACK | BYE | CAN | INV | OPT | REG |
|---|---|---|---|---|---|---|---|---|---|
| Diver- | 18x | | h | — | — | — | o | — | — |
| sion | | | | | | | | | |

16. The method according to claim 12, wherein for connections between the SIP network and a further network SIP-messages or SIP-T-messages are bidirectionally converted to a protocol of the further network.

17. The method according to claim 16, wherein the further network is a telecommunication network, in which signaling messages are transported according to one of the following protocols: analog user connection protocol, digital user connection protocol, ISDN User Part ISUP, ISUP+, Bearer Independent Call Control BICC.

18. The method according to claim 16, wherein the further network is a mobile radio network or a network according to one of the following protocols: Voice over DSL VoDSL, ITU-T H.323.

19. The method according to claim 18, wherein the parameters and messages required for signaling call diversions are converted according to the Table below between ISUP or BICC and SIP or SIP-T:

| ISUP/BICC | SIP/SIP-T |
|---|---|
| IAM | INVITE |
| Original Called Number | (Diversion Header, |
| Redirecting Number | (name-addr, |
| Redirection Information (reason, | reason, counter, limit)) |
| counter) | |
| ACM, CPG | Provisional Response 18x |
| Call Diversion Parameter | (Diversion Header, (reason)) |
| Redirection Number | Diversion Header (name-addr) |
| ACM, CPG | 3xx response (to INVITE) |
| Call Diversion Parameter | (Diversion Header, (reason)) |
| Redirection Number | Diversion Header (name-addr) |
| | Contact |

20. The method according to claim 13, wherein for connections between the SIP network and a further network SIP-messages or SIP-T-messages are bidirectionally converted to a protocol of the further network.

21. The method according to claim 14, wherein for connections between the SIP network and a further network SIP-messages or SIP-T-messages are bidirectionally converted to a protocol of the further network.

22. The method according to claim 12, wherein a received SIP Response 3×× is converted to a sent SIP Provisional Response 18×by a SIP network element executing the call diversion, wherein an information element CONTACT of the Response 3×× is mapped onto the diversion codes of the Provisional Response 18×.

23. The method according to claim 22, wherein the received SIP Response 3×× is converted according to the Table below to the sent SIP Provisional Response 18×:

| SIP Response 3xx | SIP Provisional Response 18x |
|---|---|
| (Diversion Header, (reason)) | (Diversion Header, (reason)) |
| Diversion Header (name-addr) | Diversion Header (name-addr) |
| Map CONTACT onto Diversion | |
| Header | |

24. The method according to claim 13, wherein a received SIP Response 3×× is converted to a sent SIP Provisional Response 18×by a SIP network element executing the call diversion, wherein an information element CONTACT of the Response 3×× is mapped onto the diversion codes of the Provisional Response 18×.

25. The method according to claim 14, wherein a received SIP Response 3×× is converted to a sent SIP Provisional Response 18×by a SIP network element executing the call diversion, wherein an information element CONTACT of the Response 3×× is mapped onto the diversion codes of the Provisional Response 18×.

26. The method according to claim 16, wherein a received SIP Response 3×× is converted to a sent SIP Provisional Response 18×by a SIP network element executing the call diversion, wherein an information element CONTACT of the Response 3×× is mapped onto the diversion codes of the Provisional Response 18×.

27. The method according to claim 12, wherein the received SIP Response 3×× is converted according to the Table below to a sent ISUP/BICC RELEASE message:

| SIP | ISUP/BICC |
|---|---|
| Response 3xx | REL with Cause 31 (optional) |
| (Diversion Header, (reason)) | Parameter “Redirection Information” |
| Diversion Header (name-addr); | comprises reason |
| Contact | Redirection number |

28. The method according to claim 27, wherein an ISUP/BICC RELEASE message is converted according to the Table below to a sent ISUP/BICC Address Complete Message or Call Progress Message:

| ISUP/BICC | ISUP/BICC |
|---|---|
| REL with Cause 31 (optional) | ACM, CPG |
| Parameter “Redirection Information” | Call Diversion Parameter |
| (comprises reason) | Redirection Number |
| Redirection number | |
